(19) United States
(12) Patent Application Publication
(10) Pub. No.: US 2019/0099779 A1
(43) Pub. Date: Apr. 4, 2019

(54) Broadcast Spreader Mechanism

(71) Applicant: Thomas E. Farmer, Galveston, TX (US)

(72) Inventor: Thomas E. Farmer, Galveston, TX (US)

(21) Appl. No.: 16/109,596

(22) Filed: Aug. 22, 2018

Related U.S. Application Data
(60) Provisional application No. 62/565,734, filed on Sep. 29, 2017.

(51) Int. Cl. B05C 19/04

(52) U.S. Cl. CPC B05C 19/04; A01C 17/001

(57) ABSTRACT

An apparatus, for distributing granular material stored in a container having an outlet, includes a housing comprising a bracket mountable to the container and a vane hingedly connected to a side of said central bracket. The housing has means for fixably positioning the vane relative to the bracket to adjust an angle of the vane relative to the bracket. The central bracket is configured to support a power source having a driving shaft extending along an axis aligned with the bracket, a spreader plate coupled to the shaft for rotation therewith, and a return spring around the shaft and between the spreader plate and the power source. When ON, the power source drives the shaft causing the spreader plate to rotate and translate along the shaft axis between a closed and open position. When the power source is OFF, the return spring biases the spreader plate in the closed position.

### CROSS-REFERENCE TO RELATED APPLICATION

This application claims the benefit of U.S. Provisional Application Ser. No. 62/565,734, filed on Sep. 29, 2017, which is hereby incorporated by reference herein in its entirety.

### BACKGROUND

### 1. Field

The present disclosure relates generally to broadcast spreader mechanisms that that are mounted to mobile or stationary equipment and the like.

### 2. State of the Art

A common type of particulate spreader comprises a distribution member, such as a spinning disk, mounted for rotation about an upwardly extending rotary axis. Material such as seed is typically directed from a container, such as a hopper, through an outlet port in the container and onto a spinning disk. On contact with the upper surface of the spinning disk centrifugal force spreads the material in an outward radial direction from the spinning disk. The direction and width of the flow cannot be readily controlled.

### SUMMARY

According to one aspect, further details of which are described below, an apparatus for distributing granulated material stored in a container having an outlet port includes a housing which can control the direction (i.e., left to right) and width (wide or narrow) of a stream of granular material spread by a rotary spreader housed in the housing. Granular material may include, but is not limited to: seeds, sand, grit, salt, fertilizer, lime, herbicide, insecticide; and animal feed such as, but not limited to, corn, milo, and maze, protein pellets, game feed, bird feed and fish feed. Users of such an apparatus can more precisely distribute granular material to targeted areas rather than being broadcast widely in many other directions. For example, a user may mount the spreader to a vehicle (e.g., a lawn tractor or all-terrain vehicle) and fill the container with granular grass fertilizer. Such fertilizer would be wasted if it fell on areas such as patios and walkways rather than on grass adjacent to such patios and walkways. A user of the spreader according to this disclosure may configure the spreader so that the flow of fertilizer is directed away from the patios and walkways and toward the grass as the vehicle passes those areas.

The housing includes a central bracket configured to mount to the container and at least one vane hingedly connected to a side of the central bracket. The housing has means (e.g., wingnuts and bolts) for fixably positioning the vane relative to the central bracket in order to adjust an angle of the vane relative to the bracket. The central bracket is configured to support 1) a power source having a driving shaft extending along an axis of rotation of the shaft, 2) a spreader plate coupled to the driving shaft for rotation therewith, and 3) a return spring encircling the threaded shaft and disposed between the spreader plate and the power source. The spreader plate is operably disposed beneath and aligned with the outlet port of the container for distribution of the granular material therefrom. The return spring is configured to bias the spreader plate in the closed position, blocking the flow of granular material from the outlet port of the container, when the power source is turned OFF. Also, the power source is configured to rotationally drive the driving shaft when the power source is turned ON, causing the spreader plate to rotate and translate along the axis of the shaft from the closed position to an open position.

In one embodiment, the bracket includes an upper mounting flange for mounting to a mounting flange of the container surrounding the outlet port, and includes a lower mounting flange spaced axially from the upper mounting flange. The lower mounting flange is configured for mounting the power source in spaced relation from the outlet port. The vane may include a deflecting surface configured to extend from the central bracket to impinge upon and direct some of the granular material distributed from the spreader plate. The deflecting surface is substantially solid and does not permit the granular material to pass through the deflecting surface. The deflecting surface may be planar, and may be flat or curved.

In one embodiment, the vane extends along a vertical or otherwise upright plane that is parallel to the axis of rotation of the driving shaft and is configured to rotate about a pivot axis that is parallel to the axis of rotation of the driving shaft. The pivot axis extends through a connector connecting the vane to the central bracket. In one embodiment, the bracket has an intermediate flange spacing the upper and lower mounting flanges. The vane is configured to rotate in a horizontal plane between a closed position, in which the vane extends adjacent to the side of the central bracket, and a fully open position, in which the vane extends parallel to a plane of the intermediate flange. In one embodiment, the vane is configured to rotate through about 90 degrees in a horizontal plane.

In one embodiment, the housing includes a funnel having an upper opening aligned with the outlet port of the container, and the upper opening is configured to receive granular material passing through the outlet port. The funnel has a lower opening configured to direct received granular material to the spreader plate. The lower opening is defined by a lip upon which the spreader plate rests in the closed position to block the lower opening when the power source is OFF.

In one embodiment, the apparatus includes means for adjusting an amount of translation of the spreader plate along the driving shaft. In one embodiment, the driving shaft is threaded, and the spreader plate is mounted on the threaded shaft with a coupler provided with internal threads that interface to the threaded shaft. In one embodiment, the means for adjusting an amount of translation of the spreader plate include a spring stop that encircles the threaded shaft and engages a bottom part of the return spring, and means for fixably moving the return spring stop along the threaded shaft. In another embodiment, the means for adjusting the amount of translation include a member that encircles the threaded shaft and that is disposed inside the return spring, and a clamp member encircling the return spring and moveable relative to the member, and such clamp member clamping the return spring to a user-selected portion of the member.

In one embodiment the apparatus further includes an upper bracket having first and second opposite ends and a middle portion, the middle portion defining a hole therethrough. Also, the apparatus includes a hollow shaft having opposite top and bottom ends, the top end fitting in slidable engagement through the hole in the upper bracket. The hollow shaft is configured to receive the driving shaft through the bottom end of the hollow shaft. Also, the apparatus includes a lower bracket having first and second opposite ends and a middle portion having a bottom surface. The bottom surface of the middle portion of the lower bracket defines a lower bracket opening aligned with the hollow shaft and is configured to receive the driving shaft. The lower bracket defines a set screw hole in communication with the lower bracket opening, and the middle portion of the lower bracket is attached to the hollow shaft. Additionally, apparatus includes a set screw received in the set screw hole for engaging the received driving shaft and retaining the lower bracket at a user-selected axial position along the driving shaft.

Also, the apparatus includes first and second sets of chain links having opposite upper and lower ends. The upper ends of the first and second sets of chain links are respectively attached to the first and second ends of the upper bracket. The lower ends of the first and second sets of chain links are respectively attached to the first and second ends of the lower bracket. The spreader plate has a central plate-hole therethrough, and top and bottom surfaces. The upper bracket is attached to the bottom surface of the spreader plate. The central plate hole of the spreader plate is aligned with the upper-bracket hole of the middle portion of the upper bracket. The central plate-hole fits over the top of the shaft, and the return spring is located around the hollow shaft and the driving shaft and located between the upper and lower brackets. Turning the power source ON causes the driving shaft to rotate the spreader plate and the first and second sets of chain links and generate an outwards centrifugal force causing the spreader plate to translate from the closed position to an open position thereby at least partly compressing the return spring. Upon turning the power source OFF and ceasing rotation of the spreader plate, the return spring causes the spreader plate to return to the closed position.

### BRIEF DESCRIPTION OF THE DRAWINGS

FIG. 1 is an isometric view of a spreader and hopper with guide vanes shown in an intermediate position, in accordance with an aspect of the disclosure.

FIG. 2 is an exploded assembly view of the spreader and hopper of FIG. 1.

FIG. 3 is a front elevation view of the spreader and hopper of FIG. 1, with the guide vanes in a fully closed position adjacent to the sides of a central bracket.

FIG. 4 is an isometric view of the spreader and hopper of FIG. 1, viewed from a bottom and front side, and showing the guide vanes in fully opened positions.

FIG. 5 is an isometric view of the spreader and hopper of FIG. 1, viewed form a bottom and rear side, and showing the guide vanes in an intermediate position.

FIG. 6 is a front elevation view of the spreader and hopper of FIG. 1, with a left guide vane shown in a fully open position and a right guide vane shown in a fully closed position.

FIG. 7 shows an embodiment of a spreader plate translation mechanism in accordance with another aspect of the disclosure.

FIG. 8 shows an exploded assembly view of the spreader plate translation mechanism in FIG. 7.

FIG. 9 shows a front elevation view of another embodiment of a spreader plate translation mechanism.

### DETAILED DESCRIPTION

The following description is directed to a spreader for spreading granular or powdery material such as, but not limited to: seeds, sand, grit, salt, fertilizer, lime; and animal feed such as, but not limited to, corn, milo, and maze, protein pellets, game feed, bird feed and fish feed. The spreader of the present invention is denoted generally by the numeral 100.

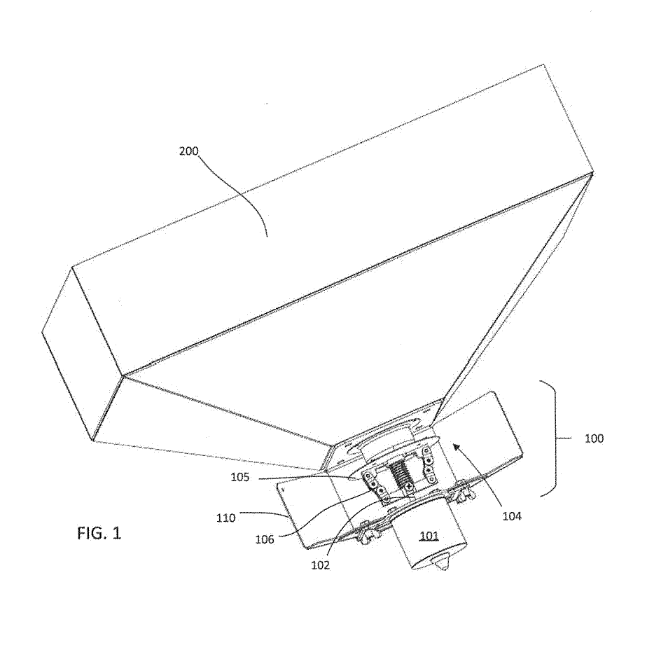

The terms “hopper” and “container” are hereinafter regarded as equivalent terms. It will be understood that the terms “upper and lower”, “front and rear”, and “top and bottom” are used for convenience to describe relative directional reference in the common orientation of spreader 100 as shown, for example, in FIG. 1.

The spreader 100 is configured to be coupled to a hopper or container 200 (hereinafter referred to as a hopper), as shown in FIG. 1. The hopper 200 may be mountable to a moveable vehicle, or to a stationary object. In one embodiment the spreader 100 comprises a power source (e.g., an electric motor) 101, a driving shaft 102 operatively driven by the power source 101, and a spreader assembly 104 coupled to the shaft 102. The spreader assembly 104 includes a spreader plate 105 and a spreader plate translation mechanism 106 configured to operatively regulate translation of the spreader plate 105 in a vertical direction as will be described in greater detail below.

As shown in FIG. 1, the spreader 100 is shown in an OFF state, where the spreader plate 105 is in a closed position relative to the hopper 200, so as to block any granular material in the hopper 200 from exiting the hopper 200. As will be described in greater detail below, when the power source 101 is turned ON, the power source 101 drives the shaft 102 to cause the spreader plate 105 and the spreader plate translation mechanism 106 to rotate together. The rotation of the spreader plate translation mechanism 106 causes the spreader plate 105 to translate downward in a direction toward the power source 101, thereby moving the spreader plate 105 away from its closed position to an open position in which any granular material in the hopper 200 may be permitted to exit the hopper 200. Falling granular material will thereafter fall on the spreader plate 105 as it rotates. The rotation of the spreader plate 105 causes the falling granular material to be thrown out by centrifugal force outwardly from the spreader plate 105.

The travel distance of vertical translation of the spreader plate 105 between the closed and open positions controls the rate of flow of material out of the hopper—the larger the distance, the greater the flow rate and the smaller the distance the smaller the flow rate. The travel distance of the spreader plate 105 can be adjusted, as will be described in greater detail below.

To control the width and direction of the material being discharged from the spreader plate 105, the spreader 100 advantageously includes a housing 110 that also connects the power source 101 to the hopper 200, and which has at least one guide vane 114 located on the side of the spreader plate 105 that can be set into a desired position to direct at least some of the granular material along a direction of the vane 114.

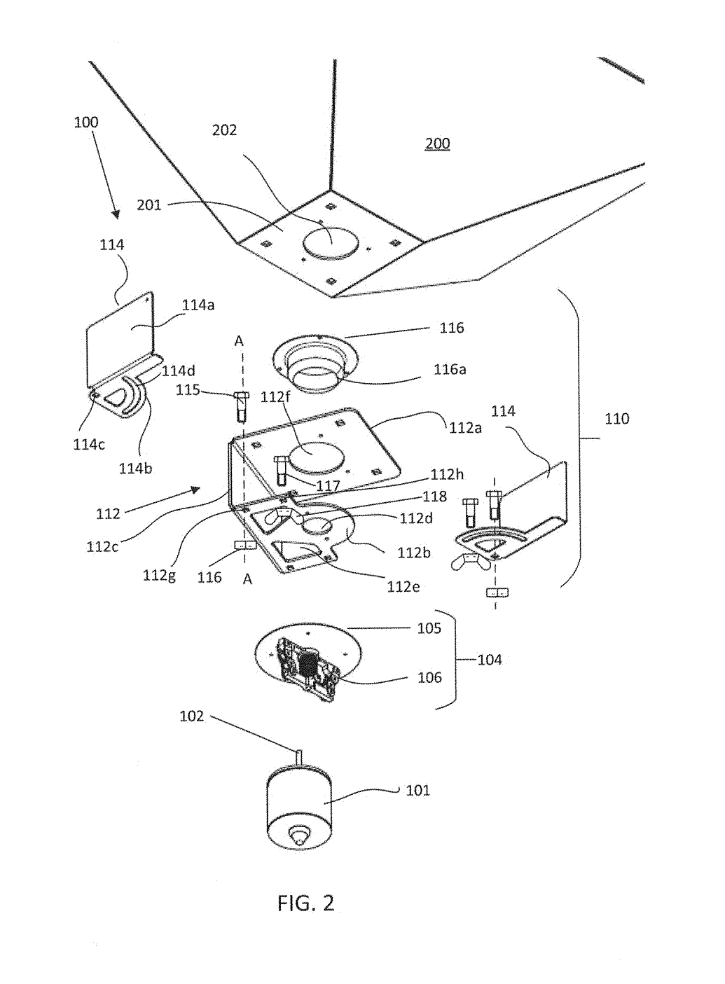

Further details of the spreader 100 will now be described with reference to FIG. 2, which shows an exploded view of the hopper 200 and the spreader 100. The hopper 200 has a mounting flange 201 on its bottom side for mounting the housing. The mounting flange 201 defines a discharge opening 202 through which granular material can pass from within the hopper to the spreader plate 105.

The housing 110 includes a central bracket 112 and at least one guide vane 114 (two vanes are shown) that is pivotally coupled to the central bracket 112 so that the vane 114 can rotate about vertical axis A-A. As shown in detail in FIG. 2, the housing 110 may also include a discharge funnel 116 for guiding falling granular material exiting from the discharge opening 202 of the hopper 200 to the spreader plate 105. Though FIG. 2 shows the funnel 116 as being separate from the central bracket 112, the discharge funnel 116 may in at least one embodiment be integrated with the central bracket 112, or may even be integrated with the hopper 200. The guide funnel 116 also provides a lip or rim 116a that acts as a bearing surface against which the spreader plate 105 abuts when the spreader plate 105 is in its closed position.

The central bracket 112 has an upper mounting flange 112a that is configured to abut and connect to the discharge funnel 116 and to the mounting flange 201 of the hopper 200. The upper mounting flange 112a also defines a hole 112f through which the funnel 116 extends. The upper mounting flange 112a and the mounting flange 201 of the hopper have mounting holes that can align and receive fasteners (e.g., screws, bolts, rivets, etc.) therethrough to couple the hopper 200 to the central bracket 112. The central bracket 112 has a lower flange 112b and a substantially solid back flange 112c, which vertically spaces the upper and lower mounting flanges 112a and 112b from one another.

The lower flange 112b is configured to mount and support the power source 101, which is suspended from the lower flange 112b. The lower flange 112b defines through holes through which fasteners (e.g., screws, bolts, rivets) can extend to corresponding fastening locations on the power source 101. The lower flange 112b also defines a shaft hole 112d through which the driving shaft 102 extends when the power source 101 is mounted to the lower flange 112b. The lower mounting flange 112b may also define at least one through hole 112e that is sized large enough to permit some falling granular material, which falls down off or past the spreader 105, to pass vertically downward through the holes 112e. As will be discussed in greater detail below, the lower flange 112b also defines mounting holes 112g and 112h for mounting the vane 114 to the lower flange 112b.

The back flange 112c is substantially solid to prevent granular material from passing therethrough. Thus, instead of being completely solid, the back flange 112c may have one or more holes that are smaller than the granular material to be distributed by the spreader 100 such that the material will be prevented from passing through the back flange 112c.

In the specific embodiment shown in FIG. 2, the housing 110 includes two guide vanes 114, one on each side (left and right) of the central bracket 112. The following discussion will discuss the left guide vane 114 in FIG. 2, however, the description also applies equally to the right guide vane 114. The guide vane 114 includes a vertical solid surface 114a and a horizontal surface 114b. The horizontal surface 114b defines a mounting hole 114c at a rear corner which aligns with the rear mounting hole 112g of the lower mounting flange 112b of the central bracket 112 and with axis A-A. Also, the horizontal surface 114b defines a curved slot 114d, which extends in a quarter circular arc. The curved slot 114d aligns with the front mounting hole 112h of the lower mounting flange 112b. A fastener such as a threaded bolt 115 may extend through the mounting hole 114c and the rear mounting hole 112g in the central bracket 112 and be connected to a threaded nut 116, which may be tightened but left loose enough to permit the vane 114 to pivot about the bolt 115 relative to the central bracket 112. A fastener such as a threaded bolt 117 extends through the aligned curved slot 114d and the front mounting hole 112h, and is connected to a threaded wingnut 118, to permit tightening and loosening by the user. The user can loosen the wingnut 118 to change the angular position of the vertical surface 114a of the vane 114 relative to the left side of the central bracket 112 and retighten the wingnut 118 once the vane 114 is set to the desired angular position.

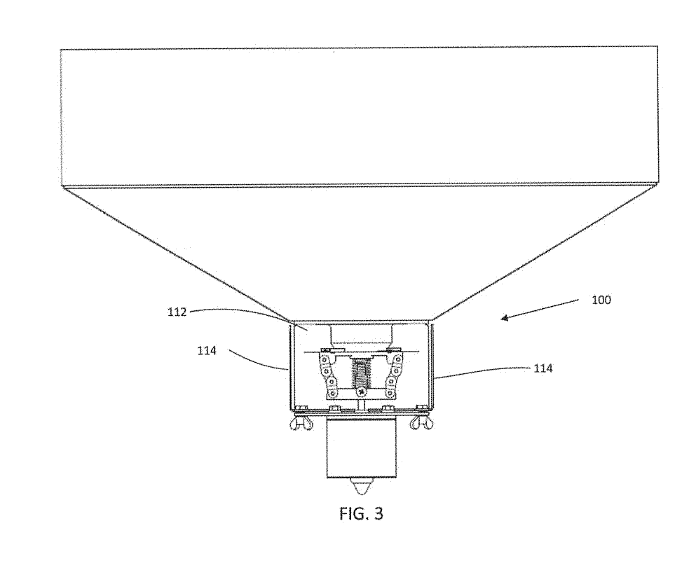

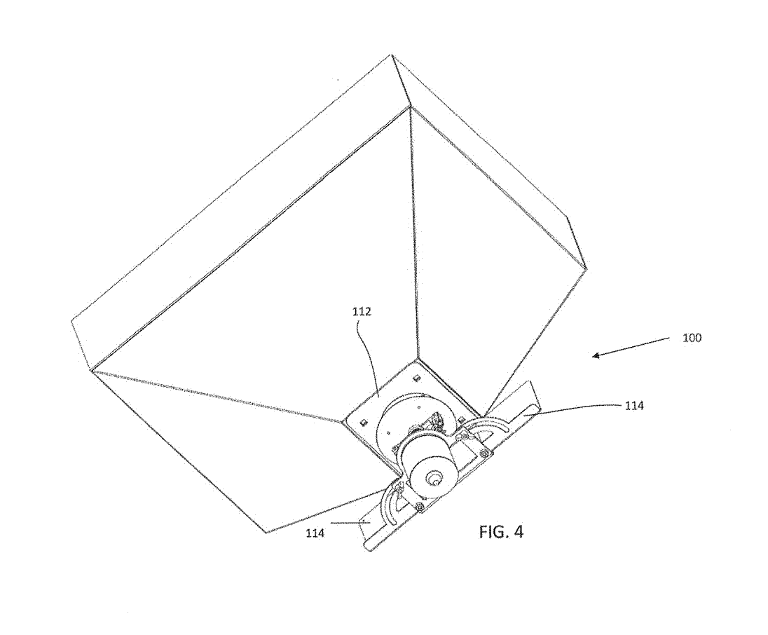

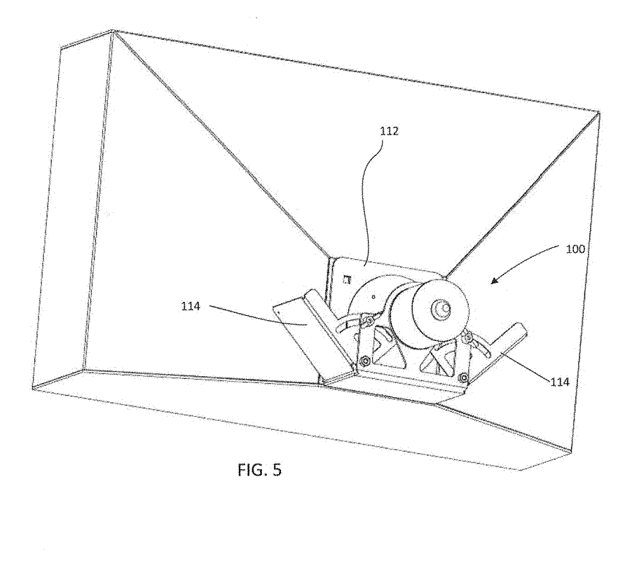

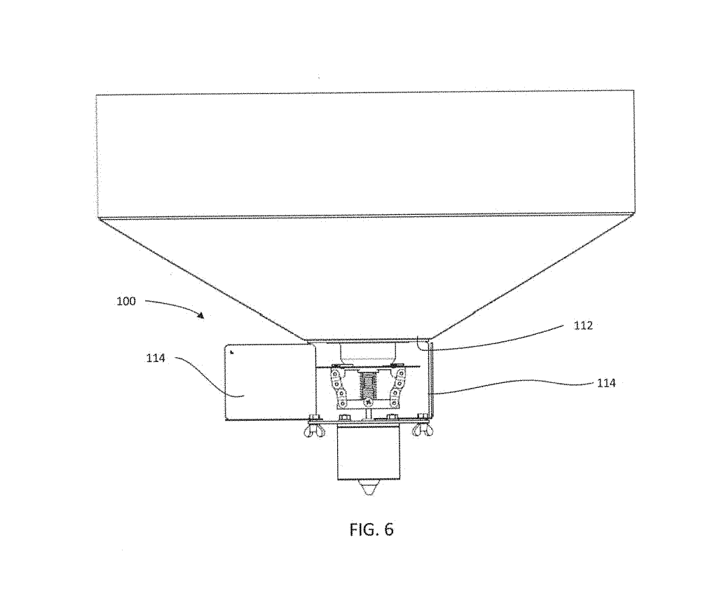

The vertical surface 114a of the vane 114 has an angular range of motion with respect to the left side of the central bracket 112a. The vane 114 can be positioned in a fully closed position in which the vertical surface 114a is essentially abutting the left side of the central bracket 112 and extends at about 90 degrees with respect to the back panel 112c. FIG. 3 shows an example of both vanes 114 in the closed position. Also, the vane 114 can be rotated to a fully open position in which the vertical surface 114a is about 180 degrees with respect to the back panel 112c, and is thus substantially parallel with the back panel 112. FIG. 4 shows an example of both vanes 114 in the fully open position. The vane 114 can be set and retained in any intermediate angular position between the fully closed and fully open position. FIG. 5 shows an example of both vanes 114 in intermediate positions. It will be appreciated that each vane 114 can be positioned independently of the other vane 114 to achieve a desired width and direction of granular material discharged from the spreader 100. FIG. 6 shows an example in which one guide vane 114 is fully closed and another guide vane is fully open.

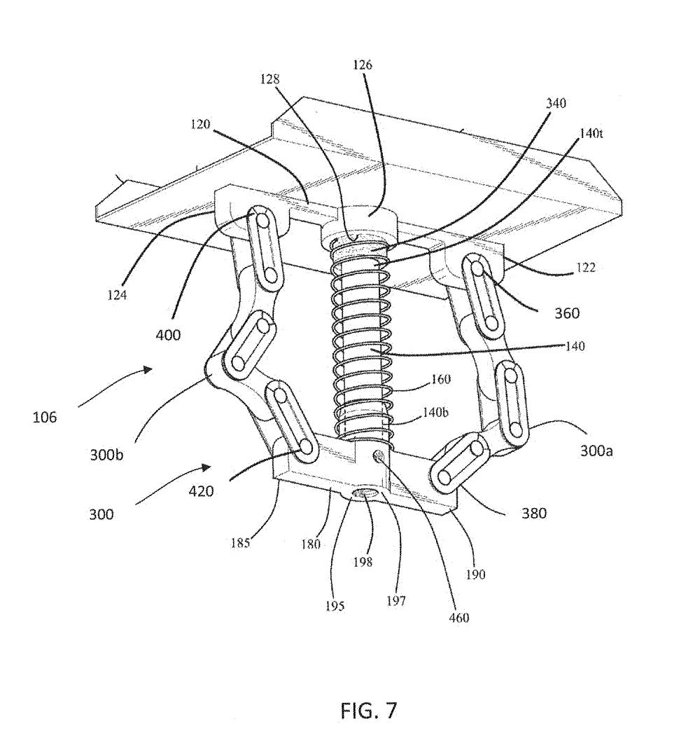

In one embodiment the spreader plate translation mechanism 106 is configured like the “spreader” described in U.S. Pat. No. 7,866,579, the entire contents of which are incorporated herein by reference, with the following exceptions. Specifically, as shown in FIG. 7, the spreader plate translation mechanism 106 may include a hollow shaft 140, a return spring 160, a lower bracket 180, and at least two sets of chain links 300. The upper and lower brackets 120 and 180 are preferably aligned in the same vertical plane. The at least two sets of chain links 300 are represented by first and second chain links 300 a and 300 b. The first and second chain links 300 a and 300 b are coplanar and diametrically aligned along a plane extending through the center of shaft 140.

The upper bracket 120 defines first 122 and second 124 opposite ends and a middle portion 126. The middle portion 126 of the upper bracket 120 defines an upper-bracket hole 128 therethrough. The shaft 140 has opposite top 140 t and bottom 140 b ends. The top end 140 t of the shaft 140 fits in slidable engagement through the hole 128 in the middle portion 126 of the upper bracket 120.

The lower bracket defines first 185 and second 190 opposite ends and a middle portion 195. The middle portion 195 having a bottom surface 197, and an upper side 199. The bottom surface 197 of the middle portion 195 of the lower bracket 180 defines a lower-bracket opening 198. A sleeve 301 extends upwards from the upper side 199 of middle portion 195. The sleeve 301 accommodates the bottom end 140 b of shaft 140.

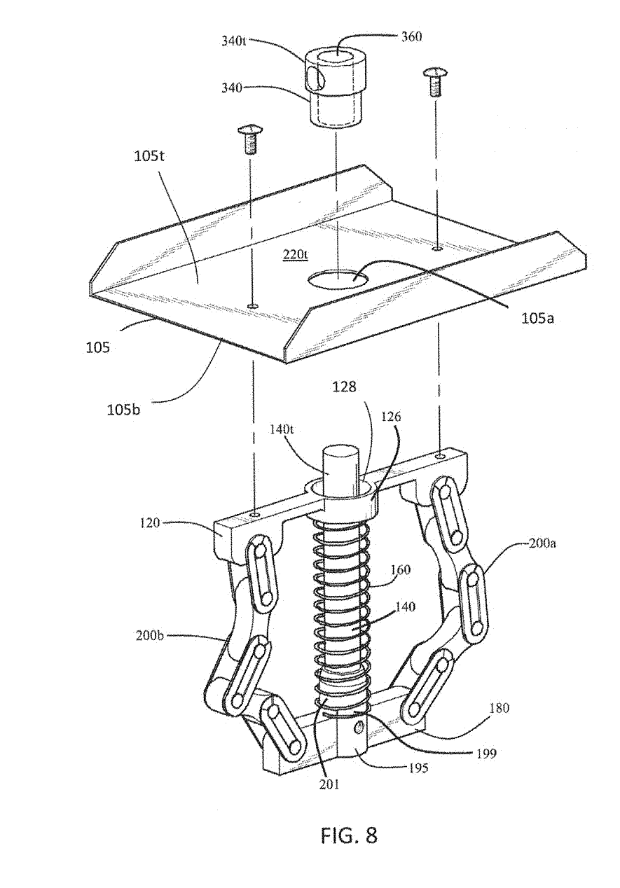

FIGS. 7 and 8 show a non-circular spreader plate, which is different in shape from the circular spreader plate 105 shown in FIGS. 1 to 6. It will be appreciated that the shape of the spreader plate is largely irrelevant for purposes of this discussion and, therefore, either shape may be used without alteration to the inventive concepts described herein. The spreader plate 105 defines a central plate-hole 105a therethrough, top surface 105t and bottom surface 105b. The central plate-hole 105a of the spreader plate 105 is aligned with the hole 128 of the middle portion 126 of the upper bracket 120. The central plate-hole 105a fits over the top 140 t of the shaft 140, and the return spring 160 is located around the shaft 140 and located between the upper 120 and lower 180 brackets. The bottom 140b of the shaft 140 is attached to the middle portion 195 of the lower bracket 180. The upper bracket 120 is attached to the bottom surface 105b of the spreader plate 105 with screws 107 (FIG. 8).

As shown in greater detail in FIG. 7, the first set of chain links 300 a defines upper 360 and lower 380 ends, and the second set of chain links 300b defines upper 400 and lower 420 ends. The upper ends 360, 400 of each set of chain links 300a and 300b are attached to the upper bracket 120 and the lower ends 380, 420 of each set of chain links 300a and 300b are attached to the lower bracket 180.

The spreader plate 105 is moveable between an up-shaft (closed) default position and a down-shaft (open) position such that in the down-shaft position the return spring 160 is at least partly compressed, and in the up-shaft default position the return spring 160 is in a substantially uncompressed state. When the spreader plate 105 is in the up-shaft default position the spreader plate 105 is mounted on and located proximate to the top 140 t of the shaft 140. It should be understood that the term “down-shaft position” merely refers to movement of the spreader plate 105 down at least a portion of the shaft 140 and is not intended to mean that the spreader plate 105 moves to the bottom 140 b of the shaft 140.

The driving shaft 102 is fitted into opening 198 of lower bracket 180, and possibly into the hollow shaft 140, depending upon the length of shaft 102. The opening 198 can be, for example, a threaded lined blind hole and the hollow shaft 140 may have an internal thread. The threads of the blind hole and the hollow shaft 140 may be aligned and both may be configured to mate with external threads on the driving shaft 102. An optional through-bore 460 can be in tangential communication with opening 198. A locking screw 461 (FIG. 1) can be inserted into optional through-bore 460 to assist in securing driving shaft 102 to the lower bracket 180 and hence to spreader 100.

When the power source 101 is turned ON, the driving shaft 102 begins to rotate and the sets of chain links 300 generate an outwards centrifugal force causing the spreader plate 105 to travel down the shaft 140 thereby at least partly compressing the return spring 160. Upon turning the power source 101 OFF, the rotation of the spreader plate 105 will cease. Upon ceasing rotation of the spreader plate 105, the return spring 160 causes the spreader plate to return to its default position (closed against the rim 116a of the funnel 116).

As shown in FIG. 1, when the power source 101 is OFF, the force of the return spring 160 urges the spreader plate 105 against the lip 116a of the funnel 116, which effectively blocks any granular material that may be in the hopper 200 from exiting the hopper and falling through the funnel 116. The stopping point of the downward travel of the spreader plate 105 dictates the open position of the spreader plate 105. The offset distance (in the vertical direction) of the spreader plate 105 between its initial closed position and its open position controls the feed rate of the material that flows out of the hopper 200 onto the spreader plate 105 for distribution therefrom. The user can control this offset distance and thus control the feed rate of the spreader 100 by adjusting the position of the lower bracket 180 along the rotating shaft 102, as will be described in greater detail below.

According to one aspect, the spreader plate translation mechanism 106 may be longitudinally positioned relative to the power source 101 and secured to the driving shaft 102 at various positions thereof using the set screw 461. In the example described above, the opening 198 in the lower bracket 180 and the shaft 140 may be hollow and have an inner threaded bore (having a total threaded length that may be at least equal to the length of the driving shaft 102), and the driving shaft 102 may have a threaded outer surface to mate with the threaded bore 198 and the threads of the hollow shaft 140 to allow the lower bracket 180 to be positioned at various locations on the driving shaft 102 by relative rotation between the shaft 102 and the lower bracket 180. The axial position of the shaft 102 and the lower bracket 180 can be retained by tightening the afore-mentioned locking screw 461.

The positioning of lower bracket 180 along the driving shaft 102, for example, can adjust the vertical travel distance (i.e., measured along the axis through the spring 160) of the spreader plate 105 and upper bracket 120 when the power source 101 is turned ON. By way of example, if bracket 180 is positioned closer to the lower flange 112b, it will allow the upper bracket 120 and spreader plate 105 to travel farther toward the lower bracket 180 when the power source 101 is turned ON, and, consequently, will allow the spreader plate 105 to move further away from the lip 116a, which may be useful for controlling the flow of larger granular material that may be exiting from the hopper 200. Also, if bracket 180 is positioned closer to the upper flange 112a, such positioning can allow the upper bracket 120 and the spreader plate 105 to travel a smaller distance away from the lip 116a when the power source 101 is turned ON, which may be useful to control the flow of smaller granular material that may be exiting the hopper 200.

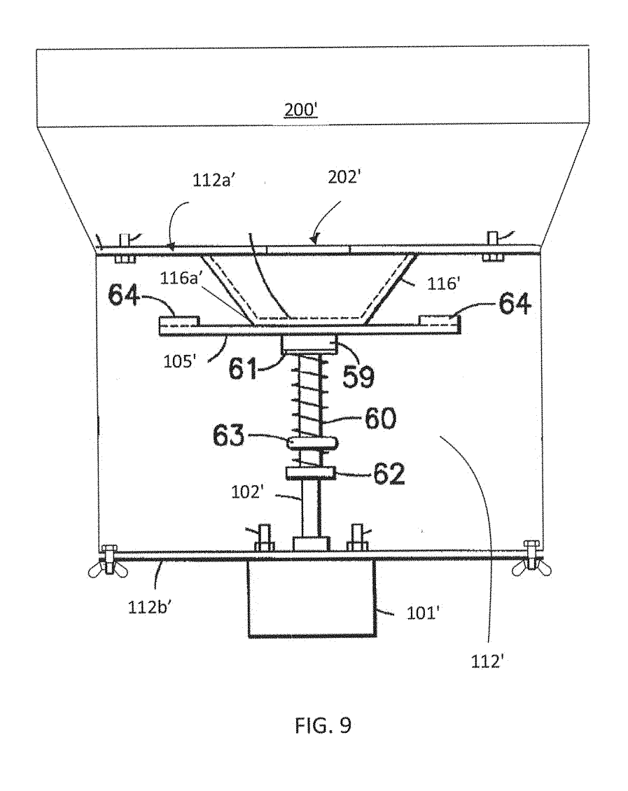

As an alternative embodiment, the spreader plate 105 and translation mechanism 106 described above can be replaced with a spreader plate and spreader plate translation arrangement described in U.S. Pat. No. 7,306,175 (Farmer), the entire contents of which are incorporated herein by reference. In the following discussion, element like those of spreader 100 are given like reference numbers appended with a prime (′) in FIG. 9. For example, a power source 101′ has a threaded driving shaft 102′ that can rotate when the power source 101′ is turned on. Also, a spreader plate 105′ may define a central opening (not shown) with an internally threaded coupling 59 that mates with the threaded driving shaft 102′. A return spring 60′ surrounds the shaft 102′ and is disposed between the spreader plate 105′ and the lower flange 112b′ of central bracket 112′. Preferably, a washer 61 or other suitable friction reducing member such as a bearing or like means is disposed between the top end of the return spring 60′ and the bottom side of the coupling 59. The lower end of the return spring 60′ is positioned along the rotating shaft 102′ by a spring stop 62. The user can manually adjust the position of the spring stop 62 along the driving shaft 102′ by unscrewing and screwing one or more set screws (not shown) that engage the rotating shaft 102′ as is well known in the mechanical arts. In this manner, the user can adjust the position of the lower end of the return spring 60′ along the rotating shaft 102′.

A hose clamp 63 or other like member encircles the return spring 60′ over a portion of the spring stop 62. The return spring 60′ and/or hose clamp 63 can be moved up or down the spring stop 62 and the hose clamp 63 tightened by the user such that the return spring 60′ is clamped to a user-selected portion of the spring stop 62. In this manner, the user can i) adjust the position of the lower end of the return spring 60′ along the rotating shaft 102′, ii) adjust the effective length of the return spring 60′, and iii) adjust the spring force applied by the return spring 60′. In the preferred embodiment, the spring stop 62 extends along the helical thread of the rotating shaft 102′ over a total length of 1-2 inches. The return spring 60′ and/or hose clamp 63 can be moved up or down this 1-2 inch length of spring stop and the hose clamp 63 tightened such that the return spring 60′ is clamped thereto. This configuration advantageously provides a wide range of adjustability for i) the position of the lower end of the return spring 60′ along the rotating shaft 102′, ii) the effective length of the return spring 60′, and iii) the spring force applied by the return spring 60′.

The top surface of the spreader plate 105′ preferably includes a set of projections 64 at its periphery that throw material from the spreader plate 105′ as it rotates. When the shaft 102′ is not rotating, the return spring 60′ biases the spreader plate 105′ in a closed position against the funnel lip 116a′, thereby preventing material from flowing out of the hopper 102 onto the spreader plate 105′. As the shaft 102′ is initially rotated by powering up the electric power source 101′, the spreader plate 105′ rotates and moves down the helical thread of the rotating shaft 102′. The downward movement of the spreader plate 105′ continues to a stopping point where the spreader plate 105′ rotates at the rotational speed of the shaft 102′. When the shaft 102′ slows down and stops rotating by powering down the electric power source 101′, the centrifugal force of the rotating spreader plate 105′ and the return spring 60′ cause the spreader plate 105′ to move back up the rotating shaft 102′ to its initial closed position against the funnel lip 116a′. In this closed position, the return spring 60′ biases the spreader plate 105′ against the funnel lip 116a′, thereby preventing material from flowing out of the hopper 200 onto the spreader plate 105′. Push button control can be used to selectively power the electrical power source 101′ on and off and thereby provide user control over distribution by the spreader plate 105′.

The stopping point of the downward travel of the spreader plate 105′ dictates the open position of the spreader plate 105′. The offset distance of the spreader plate 105′ between its initial closed position and its open position controls the feed rate of the material that flows out of the outlet 202′ of the hopper 200 onto the spreader plate 105′ for distribution therefrom. The user can adjust this offset distance and thereby control the feed rate of the spreader by adjusting the position of the lower end of the return spring 60′ along the rotating shaft 102′ by moving the spring stop. The user can also move the return spring 60′ and/or the hose clamp 63 up or down the spring stop 62 and tighten the clamp 63 to a user-selected portion of the spring stop 62 to i) adjust the position of the lower end of the return spring 60′ along the rotating shaft 38′, ii) adjust the effective length of the return spring 60′, and iii) adjust the spring force applied by the return spring 60′. Advantageously, such adjustments enable the user to quickly and easily select an appropriate offset distance/feed rate over a wide range and thus allow the spreader to be used effectively for a broad range of products with varying size and weight.

Note that in certain configurations, the natural length of the return spring 60′ is insufficient to counteract the weight of the feed material bearing against the spreader plate 105′ and frictional forces and, thus, cannot produce the required spring forces needed to close the opening between the spreader plate 105′ and the lip 116a′ of the funnel 116′ when the rotation of the shaft 105′ is stopped (i.e., the electric power source 101′ is powered OFF). In such configurations, the user can move the return spring 60′ and/or the hose clamp 63 up the spring stop 62 and tighten the clamp 63 to thereby decrease the effective length of the return spring 60′ and increase the spring force applied by the return spring 60′ such that the “clamped” return spring 60′ produces the spring forces required to close this opening. Such adjustments are particularly useful to provide a wide gap opening for large-sized granular material or seed and/or fast distribution rates.

There have been described and illustrated herein several embodiments of a spreader and a method of its use. While particular embodiments of the invention have been described, it is not intended that the invention be limited thereto, as it is intended that the invention be as broad in scope as the art will allow and that the specification be read likewise. Thus, while particular spreader plate adjustment arrangements have been disclosed, it will be appreciated that other arrangements may be employed as well. In addition, while particular types of spreader plate shapes have been disclosed, it will be understood that other shapes of spreader plates can be used. For example, and not by way of limitation, octagonal, square, rectangular, and triangular. Also, while vanes with flat surfaces are preferred, it will be recognized that curved deflecting surfaces may be used as well or in addition to flat surfaces. It will therefore be appreciated by those skilled in the art that yet other modifications could be made to the provided invention without deviating from its spirit and scope as claimed.

What is claimed is:

1. An apparatus for distributing granulated material stored in a container having an outlet port, the apparatus comprising:
a housing comprising a central bracket configured to mount to said container and at least one vane hingedly connected to a side of said central bracket, said housing having means for fixably positioning said vane relative to said central bracket in order to adjust an angle of said vane relative to said bracket.
wherein said central bracket is configured to support 1) a power source having a driving shaft extending along an axis of rotation of said shaft, 2) a spreader plate coupled to said driving shaft for rotation therewith, and 3) a return spring encircling said threaded shaft and disposed between said spreader plate and said power source,
wherein said spreader plate is operably disposed beneath and aligned with the outlet port of said container for distribution of granulated material therefrom,
wherein said return spring is configured to bias said spreader plate in said closed position, blocking the flow of granular material from said outlet port of said container, when said power source is turned OFF, and
wherein said power source is configured to rotationally drive said driving shaft when said power source is turned ON, causing said spreader plate to rotate and translate along said axis of said shaft from said closed position to an open position.

2. The apparatus according to claim 1, wherein:
said bracket includes an upper mounting flange for mounting to a mounting flange of said container surrounding said outlet port, and includes a lower mounting flange spaced axially from said upper mounting flange, said lower mounting flange being configured for mounting said power source in spaced relation from said outlet port.

3. The apparatus according to claim 2, wherein:
said vane includes a deflecting surface configured to extend from said central bracket to impinge upon and direct some of the granular material distributed from said spreader plate, wherein said deflecting surface is substantially solid and does not permit the granular material to pass through said deflecting surface.

4. The apparatus according to claim 3, wherein:
said deflecting surface is planar.

5. The apparatus according to claim 1, wherein:
said vane extends along a plane that is parallel to the axis of rotation of said driving shaft and is configured to rotate about a pivot axis that is parallel to axis of rotation of said driving shaft, wherein the pivot axis extends through a connector connecting said vane to said central bracket.

6. The apparatus according to claim 5, wherein:
said bracket has an intermediate flange spacing the upper and lower mounting flanges, and wherein said vane is configured to rotate in a horizontal plane between a closed position in which the vane extends adjacent to the side of the central bracket and a fully open position in which the vane extends parallel to a plane of the intermediate flange.

7. The apparatus according to claim 5, wherein:
said vane is configured to rotate through about 90 degrees in a horizontal plane.

8. The apparatus according to claim 1, wherein:
said housing includes a funnel having an upper opening aligned with said outlet port of said container, said upper opening configured to receive granular material passing through said outlet port, and said funnel having a lower opening configured to direct received granular material to said spreader plate, wherein said lower opening is defined by a lip upon which said spreader plate rests in the closed position to block said lower opening when said power source is OFF.

9. The apparatus according to claim 1, wherein:
said means for fixably positioning said vane relative to said central bracket comprises at least one wingnut that interface to respective bolts that pass through said vane and said central bracket.

10. The apparatus according to claim 1, further comprising:
means for adjusting an amount of translation of said spreader plate along said shaft.

11. The apparatus according to claim 10, wherein:
said driving shaft is threaded, said spreader plate is mounted on said threaded shaft with a coupler provided with internal threads that interface to said threaded shaft, and
said means for adjusting said amount of translation include:
a spring stop that encircles said threaded shaft and engages a bottom part of said return spring, and means for fixably moving said return spring stop along said threaded shaft.

12. The apparatus according to claim 10, wherein:
said driving shaft is threaded, said spreader plate is mounted on said threaded shaft with a coupler provided with internal threads that interface to said threaded shaft, and
said means for adjusting said amount of translation include:
a member that encircles said threaded shaft and that is disposed inside said return spring, and a clamp member encircling said return spring and moveable relative to the member, said clamp member clamping said return spring to a user-selected portion of said member.

13. The apparatus according to claim 10, further comprising:
an upper bracket having first and second opposite ends and a middle portion, said middle portion defining a hole therethrough;
a hollow shaft having opposite top and bottom ends, said top end fits in slidable engagement through said hole in said upper bracket, said hollow shaft configured to receive said driving shaft through the bottom end of the hollow shaft;
a lower bracket, said lower bracket having first and second opposite ends and a middle portion, said middle portion of said lower bracket having a bottom surface, said bottom surface of said middle portion of said lower bracket defining a lower bracket opening aligned with said hollow shaft and configured to receive said driving shaft, said lower bracket defining a set screw hole in communication with said lower bracket opening, and said middle portion of said lower bracket attached to said hollow shaft;
a set screw received in said set screw hole for engaging the received driving shaft and retaining said lower bracket at a user-selected axial position along the driving shaft;
first and second sets of chain links having opposite upper and lower ends, wherein the upper ends of said first and second sets of chain links are respectively attached to said first and second ends of said upper bracket, wherein the lower ends of said first and second sets of chain links are respectively attached to said first and second ends of said lower bracket;
wherein said spreader plate has a central plate-hole therethrough, and top and bottom surfaces, wherein said upper bracket is attached to the bottom surface of said spreader plate,
wherein said central plate-hole of said spreader plate is aligned with said upper-bracket hole of said middle portion of said upper bracket, said central plate-hole fits over the top of said shaft, and said return spring is located around said hollow shaft and said driven shaft and located between said upper and lower brackets,
whereby turning the power source ON causes said driving shaft to rotate said spreader plate and said first and second sets of chain links and generate an outwards centrifugal force causing said spreader plate to translate from the closed position to an open position thereby at least partly compressing said return spring, and upon turning the power source OFF and ceasing rotation of said spreader plate, said return spring causes said spreader plate to return to said closed position.
